(19) United States
(12) Patent Application Publication
(10) Pub. No.: US 2003/0174166 A1
(43) Pub. Date: Sep. 18, 2003

(54) Specialty digital tagging within an algorithm matrix

(76) Inventors: Billy Oscar DeLaRosa, New York, NY (US); Marcos Antonio Guareno, New York, NY (US)

Correspondence Address: Billy Oscar DeLaRosa, 536 West 136th Street #3A, New York, NY, 10031, US

(21) Appl. No.: 10/095,763

(22) Filed: Mar. 13, 2002

(51) Int. Cl. G09G 5/00

(52) U.S. Cl. 345/751; 345/808

(57) ABSTRACT

An application that allows for the multiple accessing of data when two separate screens interface and act as a single entity. The invention incorporates multiple imaging between two fixed and changing screens which allows a third set of images and characters to be projected on command. Once the images are projected the user can obtain detail information from the menu created by the interaction of the two screens. The system and method supports dynamic interfacing, which allows alignment via the communication of a bull's-eye or icon that identifies that screen one and screen two are linked. When the screen is multiple active and operating as a parallel system, the processor is able to distribute the data, communicate among corresponding applications and allow for redistribution of the data. From this exchange the user is able to stop frame the data and retrieve information and once done, the freeze frame is activated to full motion.

### CROSS-REFERENCE TO RELATED APPLICATIONS

| | | | |
|---|---|---|---|
| 3651484 | March 1972 | Smeallie | 340/172 |
| 4590555 | May 1986 | Bourrez | 364/200 |
| 5325525 | June 1994 | Shan et al. | 395/650 |
| 5636376 | June 1997 | Chang | 395/704 |
| 5978583 | November 1999 | Ekanadham | 395/703 |
| 6321373 | November 2001 | Ekanadham | 431/107 |

### OTHER REFERENCES

C. McCann et al, “A Dynamic Processor Allocation Policy for Multi-programmed Shared-Memory Multiprocessors” ACM Trans. on Computer Systems, vol. 11 #2, May 1993, pp.146-178; Darlington et al., “Structured Parallel Programming”, IEEE Programing Models for Massively Parallel Computers, pp. 160-169, Sep.1993.

### FIELD OF SEARCH

04,705,706,670,672,673,674,676,707

### REGARDING FEDERALLY SPONSORED RESEARCH OR DEVELOPMENT

Not applicable

### REFERENCE TO A SEQUENCE LISTING

Not Applicable

### BACKGROUND OF THE INVENTION

The fields of endeavor which the, idea embraces are 395/703,704,705, 706,670,672,673,674,676,707.

### Overview

Specialty digital tagging within an algorithm matrix is a multi task programming system that interfaces with executions parallel to each other within a common platform. For example, if one sequence contains a coded strip it may interface on command by a second scene sequence which may notify or instruct the first sequence the nature of command. By the use of a coded strip invisible to the naked eye instructions are delivered to a digital sequence that are transmitted to a second scene or matrix, that allows for the transferring of data in a two way transaction, and the manipulation of that data to change the actual pictures, titles, or any identi-fications between the two scenes. For example., if scene one contains a pair of shoes that a performer is wearing, the individual watching such scene may desire to know all the details about a particular pair of shoes. A digital tag on the shoe would allow the individual to access the item, either by pointing or clicking a mouse or to touch the screen. A second scene would automatically appear that would establish a field of inquiry within the coded matrix. In this instant all memory used by the program during the course of execution may be allocated from the outset of the program and modified or instead be allocated during execution once a decision is made as to the inquiry. Implicit execution takes place as a result of a specific tag or code from the first scene that has been parallel and identified by the second scene. An example of implicit allocation is the allocation of a virtual memory environment based on the connecting of the two scenes to establish an inquiry.

Establishing a parallel execution environment requires a source scene or matrix to establish the field of potential inquiries and for a second scene to identify these inquiries on an isolated basis. This type of resource is physical and requires the use of processes, memory and other devices that can accommodate mass storage, visualization and other specialty purpose instruments (optical scanner, etc.). Thus, the resources are shared at multiple parallel applications and the program must be written to accomodate the different environments in which utilization is required. For example, the number of processors on which an application may run must be flexible to adapt to full scale of inquiries that can be incorporated into the first scene. Therefore, the data input established in the coded matrix of scene one would be able to coordinate and instruct scene two as to the underlying information available through the tagging process. In this regard the performance of computations are both effective by the interfacing of the two sets of instructions in the multiprocessing and run time compilations. See J. Saltz, H. Berryman, “Concurrency: Practice and experience”, vol.3(6), pp.573-592, and C. Polychronopoulos, “Multiprocessing versus Multipro-gramming”, Proceedings of the 1989 International Conference on Parallel Processing, Aug. 8-12, 1989, pp.II-223-230.

By establishing a parallel environment between the two matrix and the transfer of data within this environment, the underlying configuration supports the idea. For example, the level of exchange depends on the amount of coding established in the first scene or matrix and the transfering of that digital tag to the second scene or matrix. The item can also be speech paterns and not something visual that would allow the second scene or matrix to identify certain requests by the end-user. In this regard the voice exchange between the two scenes would be identified in the same method by which an article or item is tagged for manipulation by the second screen or matrix.

In summary, the parallel application developed interchange or interexchange of data between the matrix as the example of scene one and scene two representing “the SHOE” corresponds to the matrix tagging as a trigger to allow for manipulation by the user.

### Application

The primary matrix as indicated herein represents the first matrix screen. The code identifier of this screen consists of parallel lines running the full length of the bottom of the screen in sequence patterns with valleys and peaks that correspond with the second matrix. The alignment of these parallel lines as indicated above are synchronized by conforming one to the other to create match. This match would create a bull's-eye that would represent a lock that both matrix are in alignment, and therefore available for interaction. The application and the use of both matrix frames establishes how such frames interplay and what can be retrieved or identified from one matrix to another.

### Identifiers

The intent of the patent and application described herein is to allow for a bull's-eye lock to link both matrix as a single inter-active unit. The viewer will then be able to access the second matrix by identifying what characteristics objects and symbols the applicant wishes to further associate with. i.e. let us assume that the viewer is watching television² and a specific program identifies the lower right hand corner a bull's-eye. Thus, the identifier signals the viewer that a corresponding matrix is available to interface. Depending on the configuration of the monitor whether by touch or some other interactive device to enhance the capability of the televison screen, the viewer is able to activate the second matrix. Instantly a frame appears on the screen, representing a dual picture of the screen that selects what of the performance requires further scrutiny. At this level the second matrix becomes broadcasted to the viewer for further manipulation. In this phase the viewer is able to further refine one of many visual fields—article of clothing, location, other assets in the fields of vision, or any fact of circumstance that can be identified. Once a selection is made the screen further refines the preference into specific data describing in detail the particular item, place or thing. By retouching the bull's-eye the first matrix becomes dominant and the parallel application program is discontinued. However, it can be reactivated again by touching the bull's-eye at a different point in the actual broadcast. ² The reference to television can also play to any broadcasting medium such as computer monitors, internet access devices, active screens and or fixed public broadcasting cinemas.

### BRIEF SUMMARY OF THE INVENTION

As described under Background of Invention herein, the patent represents a system and method for dynamic scheduling and allocation of resources to allow parallel applications during the course of their execution.

Music videos, for example, are produced for the public as a means of entertainment and to advertise fashion. Acquiring the apparel has become a time consuming task and very discouraging for the consumer. This pronounced problem for the consumer has originated from failure to make available brand names and purchase locations of the apparel advertised in music videos. Still to this date, there has not been an efficient time consuming process which properly advertises apparel in music videos.

Unfortunately, while this process to tag digital videos for advertising is efficient and time consuming, significant limitations and disadvantages remain. Not all apparel advertised in digital videos will be tagged. The longevity of the tagged items depends on the apparel's manufacturer. i.e. Manufacturer can run out or stop producing item therefore, continuous display of tagged item which cannot be purchased is useless.

The viewer is able to manipulate the initial matrix by coordinating his/her desire to interface with the second matrix. By establishing well defined interactions between the two matrix, the viewer is able to use initial matrix to identify products, services or other factors broadcasted by detail analysis in the second matrix.

### BRIEF DESCRIPTION OF THE SEVERAL VIEWS OF THE DRAWING

Not Applicable

### DETAILED DESCRIPTION OF THE INVENTION

The invention incorporates multiple imaging between two fixed and changing matrix where the alignment of the matrix allows a third set of characters and images to be projected. Once the images are projected the user can obtain further details from the menu created by the interaction of the two screens. For example, screen number one carries certain signals that allows screen two, to communicate with it. These signals are in a form of a moving invisible graph along the bottom of the frame. Screen two has a similar configuration that will identify with screen one and create an alignment. In order for both screens to communicate or to identify that second screen is available to communicate with screen one, a bull's-eye or icon identifies that screen one and two are interacting with each other. i.e. A video clip is created showing the dancer wearing an elaborate wardrobe. To the left is an exotic vehicle with special features. The actress sings a song and while doing so, walks around the vehicle and eventually occupies it by opening the front door and sitting behind the steering wheel. The identifier on the video clip indicates a bull's-eye or an icon that notifies the viewer that the screen is multiple active. Thus, the viewer can now press the bull's-eye that will authorize a signal to communicate with screen two. Once screen two is activated the viewer can point at the screen or use the keyboard to select the specific garment or object in the frame. Even though screen one is being viewed it would automatically stop the sequence to allow the viewer the option to evaluate, investigate, or determine any object or thing that is available on the second screen. For the sake of simplicity let us assume that with a pointer, the actress' hat requires investigation. At that point, the hat is featured on a pop-up window within the freeze frame. From this exchange the viewer can determine the brand of the hat, and all data pertaining to it. Once this interaction is complete the video clip continues to its completion or if the viewer decides to identify another object or thing.

### Glossary of Terms

Initial matrix—represents the viewers screen or digital tagging frame.

Second matrix—represents the tagging frame that links with the initial matrix.

Bull's-eye—activator switch that links the two matrix to interact as a single digital frame. Additionally, bull's-eye is a shut off switch to separate the two matrix.

Database server—the storage medium for essential information and related data configuration, including links to the website or other placement locations.

Browser—represents an application or means to view various digital voice and picture formats.

Pop-up window—a screen within a screen that activates upon the linkage of the initial matrix and second matrix.

Matrix trigger—the alignment of the initial matrix and second matrix to establish a specific link to a particular application or secondary viewing on second matrix.

Printer—a means to create a hard copy of what is identified on second matrix.

Identifier—the use of the bull's-eye to activate the required screen broadcasted on second matrix.

As described in Background of Invention, the essence of the scheme is to bring together the initial matrix and second matrix by use of the bull's-eye. In this fashion both matrix are activated by the bull's-eye which acts as a pointer or a selector of the desired viewing. Within the description as an example under Identifiers, the scheme becomes a single application that allows the viewer the opportunity to isolate a particular sequence or view which requires further scrutiny. Once this level of performance is reached, the viewer can obtain full details via hard copy printer.

In summary, parallel applications as described herein are developed for scalable systems with multiple resources that have important characteristics:

i. Dynamism: resource application of the initial matrix is activated by the bull's-eye to establish the dynamic change during the course of computers.

ii. Reconfigurability: once, the bull's-eye establishes contact with the second matrix the screen adjusts with each stage of computations that are designed to operate multi levels of resources, either from browser to manipulate pop-up window.

iii. Shareability: the application allows for multi-level tasking to offer the viewer a series of options between the course of the required field. Thus, the operator can decide which field to select from the pop-up window based on what is identified on the matrix tagger.

The final step is establishing the hard copy by activating the identifier to printer.

We claim:

1. A method for controlling the interfacing of initial matrix to the second matrix by an alignment process identified herein as bull's-eye.
Such activator acts as a processor to either turn on or off the alignment, or identify the alignment for processing.
The application establishes parallel processing in a scalable parallel environment consisting of:
the activating of the bull's-eye to align initial matrix to second matrix;
once application is established a code specification allows readability to the specific assignment, which executes in real time.

2. The method of claim 1, wherein the steps of consolidating allows the reconfiguration of the data broadcasted on the secondary matrix through a pop-up screen.
The data would be allowed to be manipulated further by accessing a specific item.

3. The method of claim 1, further comprises the monitoring and execution of the program segment if necessary.
In this regard the basic digital strip representing the visual and audio components can be reused to identify other aspects or items as the viewer may elect.

4. The method of claim 1 and 3, wherein each program segment is reconfigurable to operate in parallel to the actual running of the system by establishing the bull's-eye that interfaces two separate matrix and the use of parallel lines running horizontal and invisible to the naked eye that are similar to the lines on the second matrix.

5. The method of claim 1, wherein the step of configuring each program segment comprises the executing of coded instructions for the initial matrix to the secondary matrix.
Thus, the functional code that accompanies the application specifically computes with the auxiliary mode program, including information describing the source level which the segment can be executed.

6. The method of claim 1 and 5, wherein one auxiliary mode program is associated with duality of the segments.

7. The method of claim 1, 2, 5, and 6, wherein each segment has a different control structure.

8. The method of claim 1, wherein each segment comprises a reconfigurable and schedule module organized in such a way where the selection is retrievable from multiple means.

9. The method of claim 8, which would allow the use of different mediums of execution to the bull's-eye—via mouse, magic wand, voice or screen touch.

10. The method of claim 1, wherein the step of configuring each program segment is accompanied independently of configuration decisions for the other program segments.
For example, once the bull's-eye lines up both matrix, one viewer can isolate the performer's dress while another viewer isolates the vehicle operated by the performer.
Both viewers could retrieve the required data independent of each other.

11. The method of claim 1, wherein the step of configuring each program segment comprises of executing each code through individual processors, memory devices, related resources, visualization devices, file systems and other hardware and software resources.

12. A system of controlling the allocation of activities through the interfacing of resources to a parallel application allowing the communication by digital means of two separate matrix to accomplish a specific objective.
